(19) United States
(12) Patent Application Publication
(10) Pub. No.: US 2019/0039824 A1
(43) Pub. Date: Feb. 7, 2019

(54) COUPLING DEVICE FOR CONNECTING INTERMODAL CONTAINERS

(71) Applicant: FORMOSA FORGES CORPORATION, Nan Tou (TW)

(72) Inventor: Jui-Cheng Hsieh, Nan Tou (TW)

(73) Assignee: FORMOSA FORGES CORPORATION, Nan Tou (TW)

(21) Appl. No.: 15/725,384

(22) Filed: Oct. 5, 2017

(30) Foreign Application Priority Data
Aug. 3, 2017 (TW) 106126193

(51) Int. Cl. B65D 90/00; F16B 21/02

(52) U.S. Cl. CPC B65D 90/0006; F16B 21/02; B65D 90/0026

(57) ABSTRACT

A coupling device for engagement with two corner castings of two intermodal containers stacked upon each other includes a positioning member and upper and lower coupling members. The lower coupling member has a lower neck portion, a lower coupling portion, and first and second shoulder surfaces disposed at a juncture between the lower neck and coupling portions. With the engagement of the shoulder surfaces with the corner casting on the lower container, the lower coupling member can be retained in the corner casting to prevent undesired separation of the containers when the containers are subjected to a lateral force during rolling with winds and waves at sea upon shipping.

### CROSS-REFERENCE TO RELATED APPLICATION

This application claims priority of Taiwanese Patent Application No. 106126193, filed on Aug. 3, 2017.

### FIELD

The disclosure relates to a coupling device for connecting intermodal containers, and more particularly to a coupling device for engagement with corner castings of intermodal containers stacked upon each other.

### BACKGROUND

A conventional coupling device for connecting two intermodal containers as disclosed in U.S. Pat. No. 7,621,414 is utilized to connect two intermodal containers stacked upon each other at upper and lower corner castings thereon, and has a central stop plate and upper and lower coupling projections extending upwards and downwards therefrom. The upper coupling projection is configured to be interlocked within the lower corner casting on the upper container, and a locking member, which is pivoted by means of a hand lever, is used to lock and unlock the upper coupling projection in this corner casting. Although such coupling device can facilitate semi-automatic unloading of the container, a manual operation of the hand lever by a stevedore for the locking and unlocking of the coupling device is required, and is difficult and inconvenient to conduct when the containers are stacked upon each other.

Another conventional coupling device as disclosed in U.S. Pat. No. 7,771,147 has opposite first and second coupling projections which are respectively inserted into corner castings of upper and lower containers so as to lock the containers with each other. The second coupling projection has a hook-shaped locking lug which slides into a hole in the corner casting of the lower container and then reaches and is retained behind the hole. However, only one side of the corresponding corner casting is connected to the coupling device, and thus the connecting area thereof tends to vary. In the case that the stacked containers are displaced and tilted during shipping, the locking coupling between the containers might become unstable, and undesired separation of the containers from each other might further occur.

### SUMMARY

Therefore, an object of the disclosure is to provide a coupling device that can alleviate at least one of the drawbacks of the prior art.

According to the disclosure, the coupling device is used for engagement with two corner castings of two intermodal containers stacked upon each other. Each of the corner castings has an accommodating chamber therein, an end wall, and an insert slot extending through the end wall for access to the accommodating chamber. The insert slot is defined by first and second long side surfaces opposite to each other in a lateral direction, and two short side surfaces each interconnecting the first and second long side surfaces. Each of the corner castings further has first and second chamfers respectively disposed at a juncture between the end wall and the first long side surface, and a juncture between the end wall and the second long side surface, and first and second inner end surfaces facing the accommodation chamber and each interconnecting the accommodation chamber and a respective one of the first and second long side surfaces. The coupling device includes a positioning member and upper and lower coupling members. The positioning member is configured to be disposed between the corner castings on the stacked intermodal containers, and has a lower surface which is disposed to movably abut against the end wall of the corner casting on a lower one of the intermodal containers, and an upper surface which is opposite to the lower surface along a central axis and which is disposed to face the end wall of the corner casting on an upper one of the intermodal containers. The upper coupling member has an upper coupling portion which is connected to and extends from the upper surface along the central axis to terminate at an upper enlarged head that is configured to be inserted into the accommodation chamber of the corner casting on the upper intermodal container through the insert slot, and an upper neck portion which is interposed between and rotatable relative to the upper enlarged head and the positioning member and which is configured to be non-rotatably received in the insert slot so as to retain the upper enlarged head in the accommodation chamber. The lower coupling member has a lower neck portion which is connected to and extends from the lower surface along the central axis and away from the positioning member to terminate at an enlarged lower coupling portion, and first and second shoulder surfaces which are disposed at a juncture of the lower neck portion and the enlarged lower coupling portion. The lower neck portion is configured to be received in the insert slot of the corner casting on the lower intermodal container and to have a first neck wall surface facing the first long side surface, and a second neck wall surface facing the second long side surface. The lower coupling portion has a profile to allow insertion thereof into the accommodation chamber of the corner casting on the lower intermodal container through the insert slot. The first shoulder surface interconnects the first neck wall surface and the lower coupling portion. The second shoulder surface interconnects the second neck wall surface and the lower coupling portion. The lower neck portion has a first width which is defined between the first and second neck wall surfaces in the lateral direction and which is less than a second width of the lower coupling portion that is defined in the lateral direction. The second width is less than a third width of the insert slot that is defined between the first and second long side surfaces in the lateral direction such that the lower neck portion is slidable in the insert slot in the lateral direction between a first lateral position, where the first neck wall surface approaches the first long side surface to bring the first shoulder surface close to the first inner end surface while the second neck wall surface is remote from the second long side surface, and a second lateral position, where the second neck wall surface approaches the second long side surface to bring the second shoulder surface close to the second inner end surface while the first neck wall surface is remote from the first long side surface.

### BRIEF DESCRIPTION OF THE DRAWINGS

Other features and advantages of the disclosure will become apparent in the following detailed description of the embodiments with reference to the accompanying drawings, of which:

FIG. 1 is a perspective view illustrating an embodiment of a coupling device according to the disclosure, and a corner casting connectable therewith;

FIG. 2 is a perspective view of the embodiment, illustrating the state where an upper neck portion is rotated relative to an upper coupling portion;

FIG. 3 is a schematic, partly sectional view illustrating a lower coupling member in a middle position relative to a corner casting;

FIG. 4 is a schematic, partly sectional view illustrating the lower coupling member in a first lateral position;

FIG. 5 is a schematic, partly sectional view illustrating an upper intermodal container moved leftwardly and rolled in a counterclockwise direction;

FIG. 6 is a schematic, partly sectional view illustrating the lower coupling member in a second lateral position;

FIG. 7 is a schematic, partly sectional view illustrating the upper intermodal container moved rightwardly and rolled in a clockwise direction; and

FIG. 8 is a schematic view illustrating the state where stacked intermodal containers connected to each other by means of conventional coupling devices or the coupling devices of the embodiment according to this disclosure.

### DETAILED DESCRIPTION

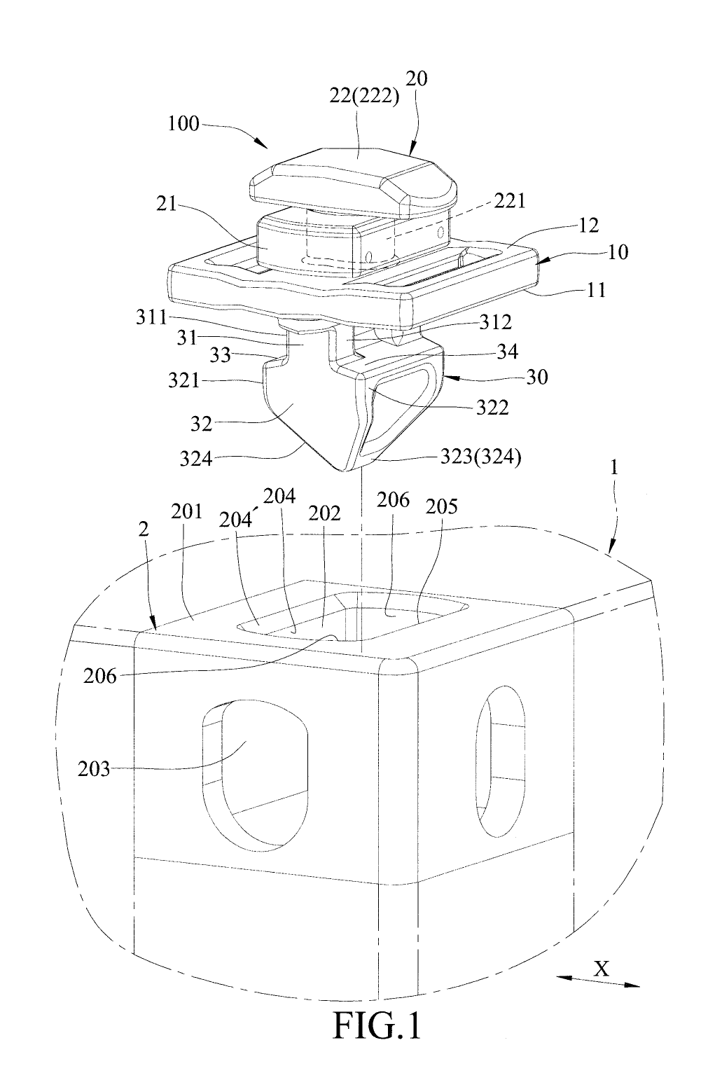

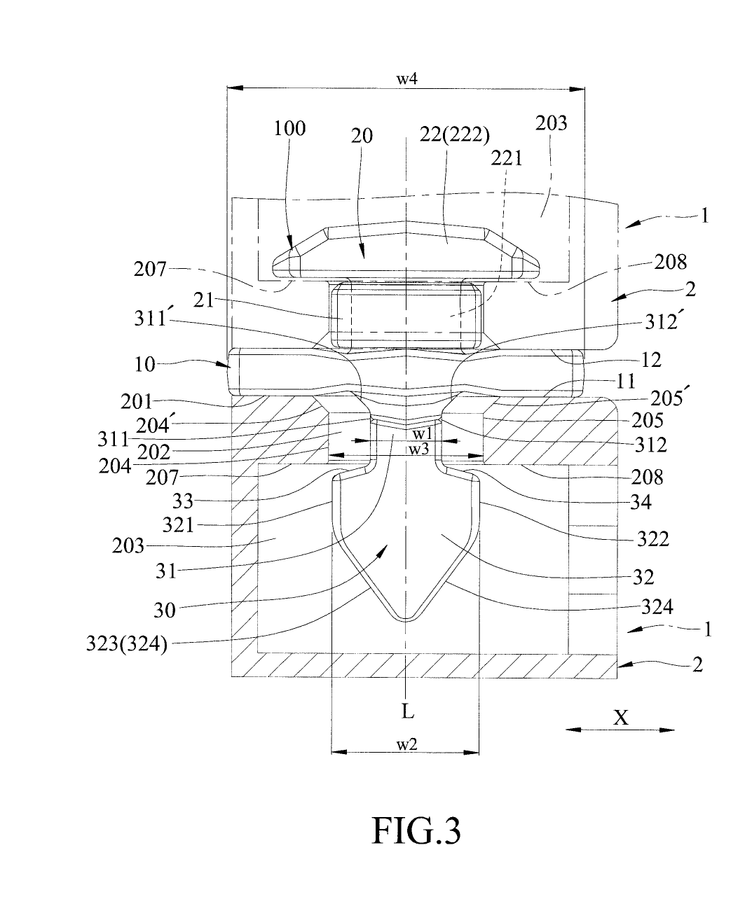

Referring to FIGS. 1 and 3, an embodiment of a coupling device 100 according to this disclosure is engaged with two corner castings 2 of two intermodal containers 1 stacked upon each other. Each corner casting 2 has an accommodating chamber 203 therein, an end wall 201, and an insert slot 202 extending through the end wall 201 for access to the accommodating chamber 203. The insert slot 202 is defined by first and second long side surfaces 204, 205 opposite to each other in a lateral direction (X), and two short side surfaces 206 each interconnecting the first and second long side surfaces 204, 205. Each corner casting 2 further has first and second chamfers 204′, 205′ respectively disposed at a juncture between the end wall 201 and the first long side surface 204, and a juncture between the end wall 201 and the second long side surface 205, and first and second inner end surfaces 207, 208 facing the accommodation chamber 203 and each interconnecting the accommodation chamber 203 and a respective one of the first and second long side surfaces 204, 205.

The coupling device 100 includes a positioning member 10, an upper coupling member 20 and a lower coupling member 30. The coupling device 100 extends along a central axis (L). The upper and lower coupling members 20, 30 are disposed at two opposite sides of the positioning member 10 along the central axis (L).

The positioning member 10 is configured to be disposed between the corner castings 2 on the stacked intermodal containers 1, and has a lower surface 11 which is disposed to movably abut against the end wall 201 of the corner casting 2 on the lower intermodal container 1, and an upper surface 12 which is opposite to the lower surface 11 along the central axis (L) and which is disposed to face the end wall 201 of the corner casting 2 on the upper intermodal container 1.

The upper coupling member 20 has an upper coupling portion 22 which has an axial section 221 that is connected to and extends from the upper surface 12 of the positioning member 10 along the central axis (L) to terminate at an upper enlarged head 222, and an upper neck portion 21 which is interposed between and rotatable relative to the upper enlarged head 222 and the positioning member 12.

Specifically, the upper neck portion 21 is rotatably sleeved around the axial section 221. The upper enlarged head 222 is configured to be inserted into the accommodation chamber 203 of the corner casting 2 on the upper intermodal container 1 through the insert slot 202. The upper neck portion 21 is configured to be non-rotatably received in the insert slot 202 so as to retain the upper enlarged head 222 in the accommodation chamber 203.

The lower coupling member 30 has a lower neck portion 31 which is connected to and extends from the lower surface 11 of the positioning member 10 along the central axis (L) and away from the positioning member 10 to terminate at an enlarged lower coupling portion 32, and first and second shoulder surfaces 33, 34 which are disposed at a juncture of the lower neck portion 31 and the enlarged lower coupling portion 32. The lower neck portion 31 is configured to be received in the insert slot 202 of the corner casting 2 on the lower intermodal container 1 and to have a first neck wall surface 311 facing the first long side surface 204, and a second neck wall surface 312 facing the second long side surface 205. The first and second neck wall surfaces 311, 312 are respectively disposed at two opposite sides of the central axis (L). The lower neck portion 31 has a first chamfer portion 311′ disposed at a juncture between the first neck wall surface 311 and the lower surface 11, and a second chamfer portion 312′ disposed at a juncture between the second neck wall surface 312 and the lower surface 11.

The lower coupling portion 32 has a profile to allow insertion thereof into the accommodation chamber 203 of the corner casting 2 on the lower intermodal container 1 through the insert slot 204 along the central axis (L). The lower coupling member 32 has two lateral portions which are disposed at two opposite sides of the central axis (L) and which are mirror images of each other in the lateral direction (X). Hence, the lower coupling portion 32 can be retained in the accommodation chamber 203 in the case that the upper intermodal container 1 is tilted and rolled relative to the lower intermodal container 1. The lower coupling portion 32 has first and second lateral surfaces 321, 322 extending from the first and second shoulder surfaces 33, 34, respectively, and substantially parallel to the central axis (L), and a taper end surface 323 extending and tapered from the first and second lateral surfaces 321, 322 to have two slope surface sections 324 converged toward each other to the central axis (L).

The first shoulder surface 33 interconnects the first neck wall surface 311 and the first lateral surface 321, and the second shoulder surface 34 interconnects the second neck wall surface 312 and the second lateral surface 322. The first and second shoulder surfaces 33, 34 are respectively disposed at two opposite sides of the central axis (L). The first shoulder surface 33 is gradually inclined away from the lower surface 11 from the first neck wall surface 311 to the first lateral surface 321, and the second shoulder surface 34 is gradually inclined away from the lower surface 11 from the second neck wall surface 312 to the second lateral surface 322.

Also, the lower neck portion 31 has a first width (w1) which is defined between the first and second neck wall surfaces 311, 312 in the lateral direction (X) and which is less than a second width (w2) of the lower coupling portion 32 that is defined between the first and second lateral surfaces 321, 322 in the lateral direction (X). The second width (w2) is less than a third width (w3) of the insert slot 202 that is defined between the first and second long side surfaces 204, 205 in the lateral direction (X). In this embodiment, a ratio of the first width (w1) of the lower neck portion 31 to the second width (w2) of the lower coupling portion 32 ranges from 0.46 to 0.67, and a ratio of the first width (w1) of the lower neck portion 31 to the third width (w3) of the insert slot 202 ranges from 0.47 to 0.63. Moreover, the positioning member 10 has a fourth width (w4) which is defined in the lateral direction (X) and which is larger than the third width (w3) of the insert slot 202.

In this embodiment, the lower coupling member 30 and the upper coupling portion 22 are integrally connected to the positioning member 10, and the upper neck portion 21 is rotatable relative to the upper coupling portion 22.

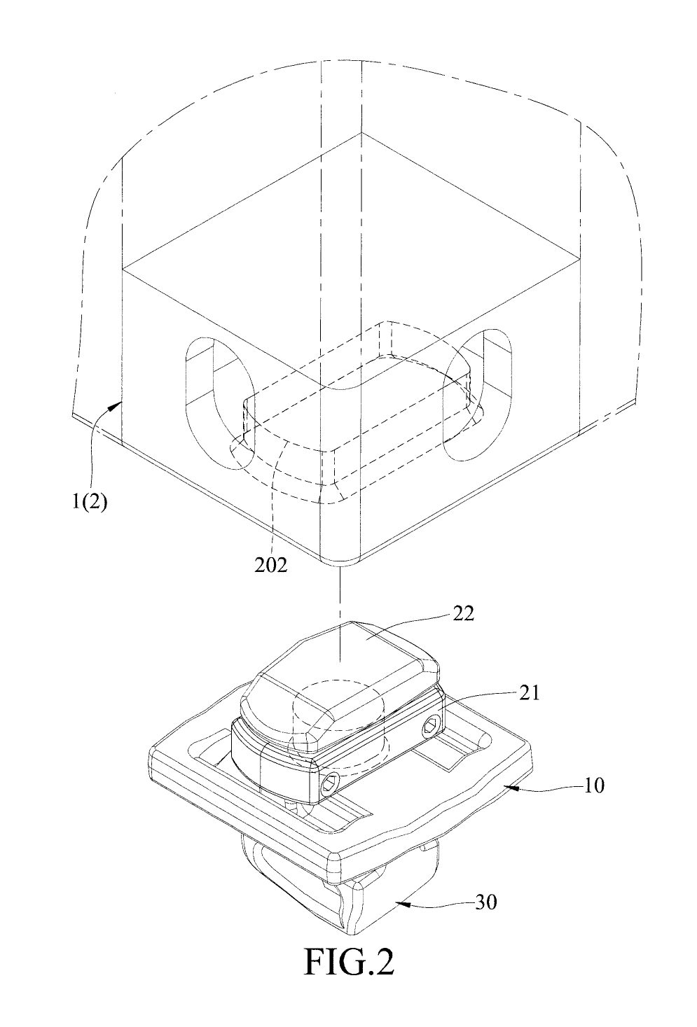

Referring to FIGS. 1 and 3, in use, the upper coupling portion 22 is retained into the accommodation chamber 203 of the corner casting 2 on an intermodal container 1 (the upper intermodal container 1) that is to be stacked on another intermodal container 1 (the lower intermodal container 1) through the insert slot 202. The operation of inserting the upper coupling portion 22 into the accommodation chamber 203 is conducted as follows. As shown in FIG. 2, the upper neck portion 21 is rotated relative to the upper coupling portion 22 by a stevedore to be flush with the upper coupling portion 22, the upper coupling portion 22 is then inserted into the accommodation chamber 203 through the insert slot 202 to place the upper neck portion 21 in the insert slot 202 (the upper neck portion 21 is non-rotatable in the insert slot 202), and the positioning member 10, the lower coupling member 30 and the upper coupling portion 22 are rotated relative to the upper neck portion 21 (about 90 degrees) to permit abutment of the upper enlarged head 222 against the first and second inner end surfaces 207, 208 of the corner casting 2 on the upper intermodal container 1 (see FIG. 3).

Next, during a lowered movement of the upper intermodal container 1 with the coupling device 100 mounted thereon to the lower intermodal container 1, the lower coupling portion 32 can be successfully inserted into the accommodation chamber 203 of the corner casting 2 on the lower intermodal container 1 through the insert slot 202 since the second width (w2) of the lower coupling portion 32 is designed to be less than the third width (w3) of the insert slot 202 so as to connect the upper and lower intermodal containers 1. At this stage, the upper and lower coupling portions 22, 32 are retained within the corresponding corner castings 2 on the upper and lower intermodal containers 1 such that the coupling device 100 is firmly retained to the corner castings 2.

Referring again to FIG. 3, in this connection state, the lower neck portion 31 of the lower coupling member 30 is placed in a middle position, where a distance between the first neck wall surface 311 and the first long side surface 204 and a distance between the second neck wall surface 312 and the second long side surface 205 are substantially the same, and the first and second shoulder surfaces 33, 34 are remote from the first and second inner end surfaces 207, 208, respectively.

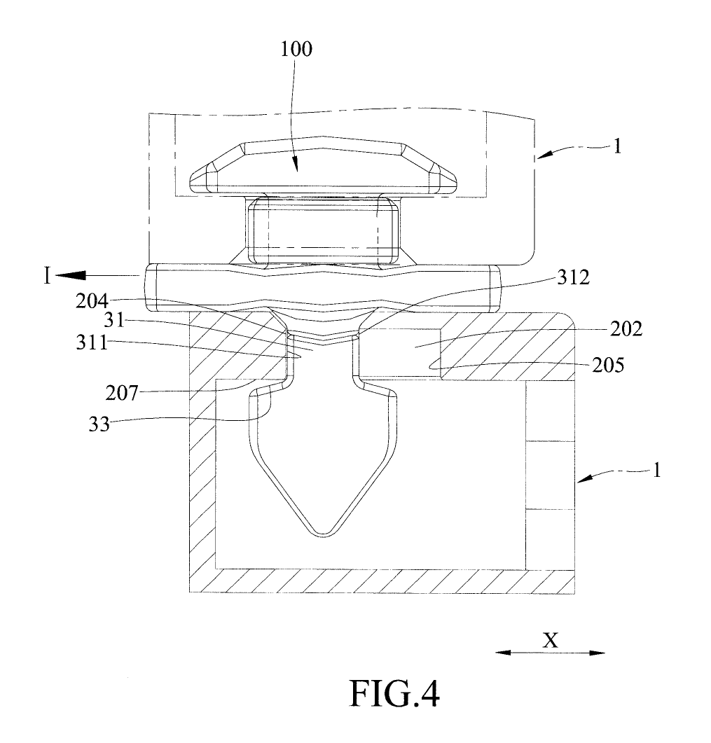

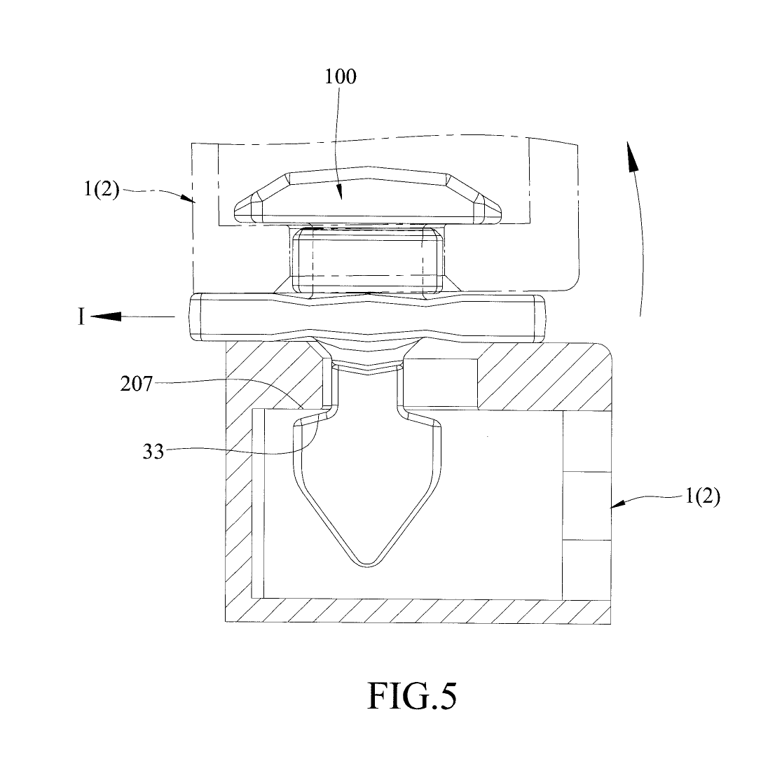

Referring to FIG. 4, once the ship is rolling with winds and waves at sea, the upper intermodal container 1 is subjected to a first lateral force (I) and hence moves in the lateral direction (X) relative to the lower intermodal container 1 such that the lower neck portion 31 of the coupling device 100 slides leftwardly in the drawing along the lateral direction (X) relative to the insert slot 202 to a first lateral position, where the first neck wall surface 311 approaches the first long side surface 204 to bring the first shoulder surface 33 close to the first inner end surface 207 while the second neck wall surface 312 is remote from the second long side surface 205. Even though the lateral force (a leftward force) tends to cause a rolling of the upper intermodal container 1 in a counterclockwise direction (as indicated by the arcuate arrow in FIG. 5) relative to the lower intermodal container 1, by the engagement and retention of the first shoulder surface 33 with and by the first inner end surface 207, tilt of the upper intermodal container 1 relative to the lower intermodal container 1 in the counterclockwise direction, and undesired removal of the upper intermodal container 1 as well can be prevented. Once the first lateral force (I) does not exist, and when an upright force parallel to the central axis (L) (which may arise from lifting of the upper intermodal container 1) is applied to the lower coupling member 30, the first shoulder surface 33 slides along and is disengaged from the first inner end surface 207 so as to permit separation of the upper intermodal container 1 from the lower intermodal container 1.

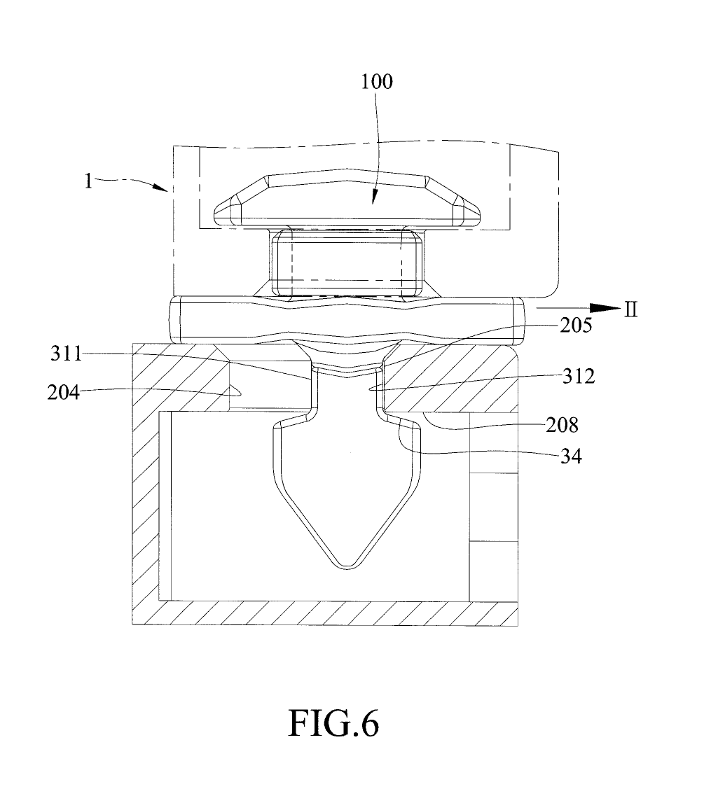

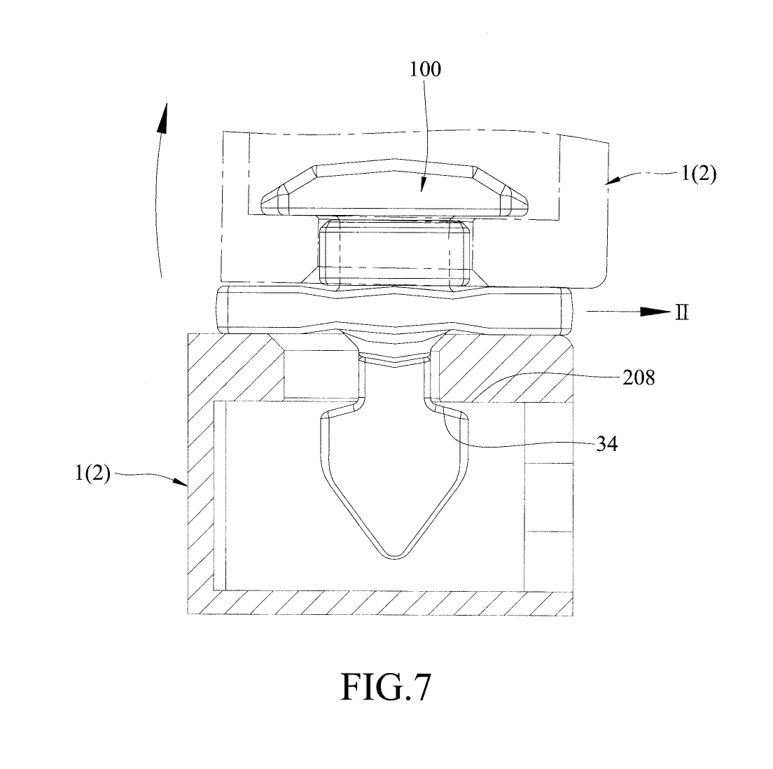

Referring to FIG. 6, the upper intermodal container 1 is subjected to a second lateral force (II) and hence moves in the lateral direction (X) relative to the lower intermodal container 1 such that the lower neck portion 31 of the coupling device 100 slides rightwardly in the drawing along the lateral direction (X) relative to the insert slot 202 to a second lateral position, where the second neck wall surface 312 approaches the second long side surface 205 to bring the second shoulder surface 34 close to the second inner end surface 208 while the first neck wall surface 311 is remote from the first long side surface 204. Even though the lateral force (a rightward force) tends to cause a rolling of the upper intermodal container 1 in a clockwise direction (as indicated by the arcuate arrow in FIG. 7) relative to the lower intermodal container 1, by the engagement and retention of the second shoulder surface 34 with and by the second inner end surface 208, tilt of the upper intermodal container 1 relative to the lower intermodal container 1 in the clockwise direction, and undesired removal of the upper intermodal container 1 as well can be prevented. Once the second lateral force (II) does not exist, and when an upright force parallel to the central axis (L) (which may arise from lifting of the upper intermodal container 1) is applied to the lower coupling member 30, the second shoulder surface 34 slides along and is disengaged from the second inner end surface 208 so as to permit separation of the upper intermodal container 1 from the lower intermodal container 1.

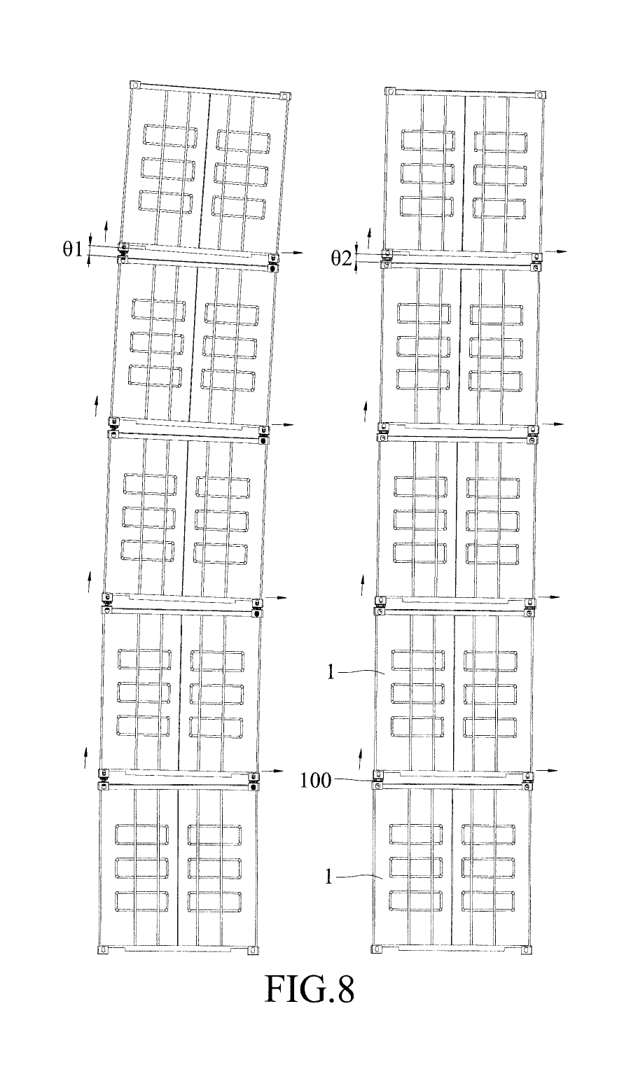

Referring to FIG. 8, the left part thereof illustrates stacked intermodal containers connected by the conventional coupling devices each having the hook-shaped locking lug to engage only one side of the corner casting. In the case that the stacked intermodal containers are displaced and tilted during shipping, the connecting area between the locking lug and the corner casting becomes less, thereby placing the stacked intermodal containers in an adverse state. The rolling angle (01) of the upper intermodal container relative to the lower intermodal container is large, and undesired removal of the coupling device from the corner casting might occur. With reference to the right part of FIG. 8 which illustrates stacked intermodal containers connected by the embodiment of the disclosure, and referring to FIG. 7, with the engagement and retention of the first shoulder surface 33 with and by the first inner end surface 207, and the engagement and retention of the second shoulder surface 34 with and by the second inner end surface 208, the rolling angle (θ2) between the stacked intermodal containers 1 is relatively small, and an unintentional separation of the stacked intermodal containers can be avoided so as to ensure a stable shipping.

In an unloading process, the upper intermodal container 1 is lifted to be separated from the lower intermodal container 1. With the slidable abutment and guidance of the inclined first and second shoulder surfaces 33, 34 against and along the first and second inner end surfaces 207, 208, the lower coupling member 30 can be automatically moved to the middle position to be removed from the insert slot 220 without any manual unlocking operation.

With the configuration and structure of the lower coupling member 32, which can be retained in the accommodation chamber 203 of the corner casting 2 by abutment against the first and second inner end surfaces 207, 208, the connection between the stacked intermodal containers 1 can be firmed during the rolling with winds and waves at sea upon shipping. Besides, the coupling device of this disclosure can be operated to lock and unlock automatically two intermodal containers 1 for facilitating loading and unloading of the containers 1.

As illustrated, with the lower coupling member 30 which can be retained in the corner casting 2 in a double-side engagement manner, an undesired separation of the connected intermodal containers can be avoided. Moreover, a manual unlocking operation is not needed during the unloading, which renders the unloading process simple and rapid, and hence reduces the operational cost.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A coupling device for engagement with two corner castings of two intermodal containers stacked upon each other, each of the corner castings having an accommodating chamber therein, an end wall, an insert slot extending through the end wall for access to the accommodating chamber, the insert slot being defined by first and second long side surfaces opposite to each other in a lateral direction, and two short side surfaces each interconnecting the first and second long side surfaces, each of the corner castings further having first and second chamfers respectively disposed at a juncture between the end wall and the first long side surface, and a juncture between the end wall and the second long side surface, and first and second inner end surfaces facing the accommodation chamber and each interconnecting the accommodation chamber and a respective one of the first and second long side surfaces, said coupling device comprising:
a positioning member configured to be disposed between the corner castings on the stacked intermodal containers, and having a lower surface which is disposed to movably abut against the end wall of the corner casting on a lower one of the intermodal containers, and an upper surface which is opposite to said lower surface along a central axis and which is disposed to face the end wall of the corner casting on an upper one of the intermodal containers;
an upper coupling member having an upper coupling portion which is connected to and extends from said upper surface along the central axis to terminate at an upper enlarged head that is configured to be inserted into the accommodation chamber of the corner casting on the upper intermodal container through the insert slot, and an upper neck portion which is interposed between and rotatable relative to said upper enlarged head and said positioning member and which is configured to be non-rotatably received in the insert slot so as to retain said upper enlarged head in said accommodation chamber; and
a lower coupling member having a lower neck portion which is connected to and extends from said lower surface along the central axis and away from said positioning member to terminate at an enlarged lower coupling portion, and first and second shoulder surfaces which are disposed at a juncture of said lower neck portion and said enlarged lower coupling portion, said lower neck portion being configured to be received in the insert slot of the corner casting on the lower intermodal container and to have a first neck wall surface facing the first long side surface, and a second neck wall surface facing the second long side surface, said lower coupling portion having a profile to allow insertion thereof into said accommodation chamber of the corner casting on the lower intermodal container through the insert slot, said first shoulder surface interconnecting said first neck wall surface and said lower coupling portion, said second shoulder surface interconnecting said second neck wall surface and said lower coupling portion, said lower neck portion having a first width which is defined between said first and second neck wall surfaces in the lateral direction and which is less than a second width of said lower coupling portion that is defined in the lateral direction, the second width being less than a third width of the insert slot that is defined between the first and second long side surfaces in the lateral direction such that said lower neck portion is slidable in the insert slot in the lateral direction between a first lateral position, where said first neck wall surface approaches the first long side surface to bring said first shoulder surface close to the first inner end surface while said second neck wall surface is remote from the second long side surface, and a second lateral position, where said second neck wall surface approaches the second long side surface to bring said second shoulder surface close to the second inner end surface while said first neck wall surface is remote from the first long side surface.

2. The coupling device as claimed in claim 1, wherein a ratio of the first width to the second width ranges from 0.46 to 0.67, and a ratio of the first width to the third width ranges from 0.47 to 0.63.

3. The coupling device as claimed in claim 1, wherein said upper and lower coupling members are disposed at two opposite sides of said positioning member along the central axis, said first and second neck wall surfaces are respectively disposed at two opposite sides of the central axis, said first and second shoulder surfaces are respectively disposed at the two opposite sides of the central axis, and said lower coupling member has two lateral portions which are disposed at the two opposite sides of the central axis and which are mirror images of each other in the lateral direction.

4. The coupling device as claimed in claim 3, wherein said lower coupling portion has first and second lateral surfaces extending from said first and second shoulder surfaces, respectively, and parallel to the central axis, and a taper end surface extending and tapered from said first and second lateral surfaces to have two slope surface sections converged toward each other to the central axis.

5. The coupling device as claimed in claim 4, wherein said first shoulder surface is gradually inclined away from said lower surface from said first neck wall surface to said first lateral surface, and said second shoulder surface is gradually inclined away from said lower surface from said second neck wall surface to said second lateral surface.

6. The coupling device as claimed in claim 1, wherein said lower neck portion has a first chamfer portion disposed at a juncture between said first neck wall surface and said lower surface, and a second chamfer portion disposed at a juncture between said second neck wall surface and said lower surface.

7. The coupling device as claimed in claim 1, wherein said lower neck portion is configured to be disposed in a middle position between the first and second lateral positions, where a distance between said first neck wall surface and the first long side surface and a distance between said second neck wall surface and the second long side surface are the same, and said first and second shoulder surfaces are remote from the first and second inner end surfaces, respectively.

8. The coupling device as claimed in claim 7, wherein said first shoulder surface is configured to be engaged with and retained by the first inner end surface when a first lateral force is applied to said lower coupling member to move said lower neck portion in the lateral direction to the first lateral position, so as to guard the upper intermodal container against rolling in a counterclockwise direction relative to the lower intermodal container, and to be slidable along and disengaged from the first inner end surface when an upright force parallel to the central axis is applied to said lower coupling member, and said second shoulder surface is configured to be engaged with and retained by the second inner end surface when a second lateral force is applied to said lower coupling member to move said lower neck portion in the lateral direction to the second lateral position, so as to guard the upper intermodal container against rolling in a clock direction relative to the lower intermodal container, and to be slidable along and disengaged from the second inner end surface when an upright force parallel to the central axis is applied to said lower coupling member.
